(19) United States
(12) Patent Application Publication
(10) Pub. No.: US 2004/0085150 A1
(43) Pub. Date: May 6, 2004

(54) Terminations for shielded transmission lines fabricated on a substrate

(76) Inventors: Lewis R. Dove, Monument, CO (US); John F. Casey, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/283,973

(22) Filed: Oct. 30, 2002

(51) Int. Cl. H01P 1/26

(52) U.S. Cl. 333/22 R

(57) ABSTRACT

A terminated shielded coplanar transmission line is fabricated upon a ground plane of Au carried by a ceramic substrate. A ribbon of KQ dielectric material is formed on the ground plane, and then a patterned layer of Au is formed over that. The pattern includes a center conductor strip generally centered on the KQ ribbon and two adjacent ground strips, with each of the latter being wide enough to extend down the sides of the KQ ribbon to join the ground plane. The ribbon of KQ has a distal end, and the Au ground strips wrap around that end to meet each other, as well as continuing to touch the ground plane proximate that distal end of the ribbon. The termination proper is formed by depositing either: two 2Z₀ resistors, each going at right angles from the center conductor to the adjacent ground strips; or, one Z₀ resistor extending beyond the end of the center conductor to reach the grounded strips that wrap around the distal end. A terminated quasi-coaxial transmission line on a substrate may be created by first fabricating one of the shielded coplanar transmission line structures just described, and then covering all of the raised portion except the termination resistor(s) with another (narrower) ribbon of KQ dielectric material, which is then subsequently covered with a layer of Au. The other end of the transmission line is coupled to a component on the hybrid using any appropriate technique.

### Reference To Related Patents

U.S. Pat. No. 6,255,730 B1 (to Dove, Casey and Blume, issued 3 July 2001) describes various thick film techniques that become possible with the recent advent of certain dielectric materials. These are KQ-120 and KQ-CL907406, which are products of Heraeus Cermalloy, 24 Union Hill Road, West Conshohocken, Pa. Hereinafter, we shall refer to these products as the “KQ dielectric,” or as simply “KQ.” In particular, that Patent describes the construction of an “encapsulated” microstrip transmission line, for which the term “quasi-coaxial” has been coined . This Disclosure concerns further novel and useful thick film techniques pertaining to both quasi-coaxial transmission lines and (in the same spirit) “shielded-coplanar” transmission lines, not heretofore practical, that may be practiced with these KQ dielectric materials. Accordingly, U.S. Pat. No. 6,255,730 B1 is hereby incorporated herein by reference.

### BACKGROUND OF THE INVENTION

A “hybrid” circuit consisting of a substrate with various thick film structures thereon that are interconnected with a plurality of ICs (Integrated Circuits) continues to be an attractive technique for creating functionally complex and high frequency assemblies from “component” ICs. It is often the case that it is necessary or very desirable to use transmission lines to interconnect these ICs, or to connect them to an external environment. We are particularly interested in the case when the transmission line is of the encapsulated microstrip type described in the incorporated Patent. By the term “encapsulated” that Patent means that the transmission line, which in their example is what would otherwise be called a microstrip, is fully shielded, with a ground completely surrounding the center conductor. It is not exactly what we would ordinarily term a “coaxial” transmission line, since its cross section does not exhibit symmetry about an axis; it has a line and a rectangular trapezoid for a cross section instead of a fat point and surrounding circle. Nevertheless, we shall find it appropriate and convenient to call it (the ‘encapsulated’ transmission line of the '730 B1 Patent) a ‘quasi-coaxial’ transmission line, which, it should be noted, is pretty small (perhaps 0.050″ wide by 0.010″ or 0.015″ high).

We are also particularly interested in another type of transmission line that would ordinarily be termed a coplanar transmission line. This is typically a three-conductor structure formed on a dielectric. One element is a center conductor trace (probably of rectangular cross section) having a ground traces (probably of much wider rectangular cross section) on either side. The ususal manner of construction is to begin with a dielectric substrate having a conductive sheet bonded to one side and that will serve as a ground plane, and then etch away two parallel strips of metal to leave the center trace with ground on both sides. A coplanar transmission line is thus not shielded, except on the sides. In particular, then, we shall also be interested in “shielded” coplanar transmission lines. By that terminology we mean that the three-conductor structure and a raised platform of dielectric material are built upon an intact ground plane that serves as a shield for one of the top or bottom of the coplanar transmission line, and that the two ground traces descend from the dielectric platform to be continuously connected at their outer edges to that ground plane.

For use in microwave hybrid circuits of the sort we are interested in, both types of transmission lines are generally comparable in physical size, and both will meander as necessary to connect to the appropriate components on the hybrid.

One of the functions performed by transmission lines in general is to assist in terminating items (inputs, outputs) in an associated impedance. Transmission lines have a characteristic impedance Z₀ (e.g., 50 Ω) and the ususal case is for the various input and output impedances to be designed to be the same, and for the Z₀ of the interconnecting transmission lines to match that impedance. That done, it is common to find a terminating resistor R of value R=Z₀ connected through a Z₀ transmission line to an item that needs terminating. There are various good reasons for doing this that will all be familiar to those who practice RF and microwave techniques. A usual term for this practice is “terminating a transmission line” or having a “terminated” transmission line connected to such and such.

It would be desirable if there were a way to use the shielded coplanar and quasi-coaxial types of transmission lines fabricated on a substrate to connect a termination resistance to an item on the hybrid needing such termination. Some prior art techniques for connecting to components, such as resistors, have involved vias. Vias add to manufacturing cost, are often an aggravation during fabrication, and are a source of pernicious inductance. What we need is a low cost, convenient and electrically acceptable way to terminate shielded coplanar and quasi-coaxial transmission lines fabricated on a substrate. What to do?

### SUMMARY OF THE INVENTION

A terminated shielded coplanar transmission line is fabricated upon a ground plane of Au carried by a ceramic substrate. A ribbon of KQ dielectric material is formed on the ground plane, and then a patterned layer of Au is formed over that. The pattern includes a center conductor strip generally centered on the KQ ribbon and two adjacent ground strips, with each of the latter being wide enough to extend down the sides of the KQ ribbon to join the ground plane. The ribbon of KQ has a distal end, and the Au ground strips wrap around that end to meet each other, as well as continuing to touch the ground plane proximate that distal end of the ribbon. The termination proper is formed by depositing either: two 2Z₀ resistors, each going at right angles from the center conductor to the adjacent ground strips; or, one Z₀ resistor extending beyond the end of the center conductor to reach the grounded strips that wrap around the distal end. A terminated quasi-coaxial transmission line on a substrate may be created by first fabricating one of the shielded coplanar transmission line structures just described, and then covering all of the raised portion except the termination resistor(s) with another (narrower) ribbon of KQ dielectric material, which is then subsequently covered with a layer of Au. The other end of the transmission line is coupled to a component on the hybrid using any appropriate technique.

### BRIEF DESCRIPTION OF THE DRAWINGS

FIG. 1 is a top perspective cut-away view of a distal end of a shielded coplanar transmission line fabricated upon a ceramic substrate and terminated by a pair of R=2Z₀ resistors, each extending from the center conductor to a different grounded side of the transmission line;

FIG. 2 is a top perspective cut-away view of a distal end of a shielded coplanar transmission line fabricated upon a ceramic substrate and terminated by a single R=Z₀ resistor extending along the direction of the center conductor and beyond the end of the center conductor to reach a grounded end of the transmission line;

FIG. 3 is a top perspective cut-away view of a distal end of a quasi-coaxial transmission line fabricated upon a ceramic substrate and terminated by a pair of R=2Z₀ resistors, each extending from the center conductor to a different grounded side of the transmission line; and

FIG. 4 is a top perspective cut-away view of a distal end of a quasi-coaxial transmission line fabricated upon a ceramic substrate and terminated by a single R=Z₀ resistor extending along the direction of the center conductor and beyond the end of the center conductor to reach a grounded end of the transmission line.

### DESCRIPTION OF A PREFERRED EMBODIMENT

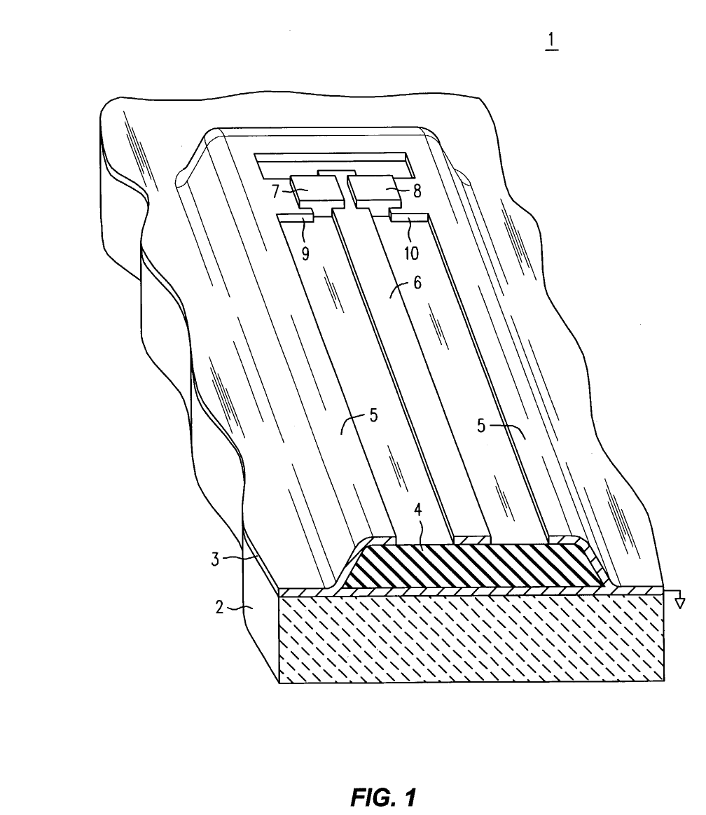

Refer now to FIG. 1, wherein is shown a top perspective cut-away view 1 of a distal end of a shielded coplanar transmission line fabricated upon a substrate 2, which could, for example be 96% alumina 0.040″ thick. The shielded coplanar transmission line is fabricated in keeping with the thick film techniques taught in the incorporated '730B1 Patent. In particular, note the ground plane 3, deposited on the “top” of the substrate 2 (i.e., on the same side as the shielded coplanar transmission line), and which, as ground planes do, may extend liberally in all directions as needed. The ground plane may be of metal, preferably gold, and if patterns therein are needed, an etchable thick film Au process, such as the Heraeus KQ-500 may be used. The shielded coplanar transmission line itself includes a base layer or strip 4 of KQ dielectric material, that meanders as needed for the desired path of the transmission line. (By “meanders” we do not necessarily mean that a serpentine path is taken—only that it goes where it needs to.) Once that base layer 4 is in place, a suitable layer or strip of metal 5 (which is preferably Au) is deposited over the entire top surface of the base layer 4. This strip or layer of metal S electrically joins the ground plane 3, and functions as an extension thereof. The strip of layer 5 is subsequently patterned to remove material whose absence produces center conductor strip 6 and lands or pads 9 and 10. Patterned layer 5 and center conductor strip 6 thus form a coplanar transmission line of characteristic impedance Z₀. It is a shielded coplanar transmission line because the ground plane 3 extends beneath it. Let us call that portion of the ground plane 3 that is beneath the transmission line a “ground shield.” Termination resistors (7 and 8) are each of an ohmic value of twice Z₀ and are subsequently placed between pads 9 and 10 and the center conductor strip 6, as shown. They may be printed on using conventional thick film techniques, or they may be actual discrete piece parts, such as surface mount chip resistors. The part of the transmission line where the termination resistors are placed is called the distal end. Presumably the other end of the transmission goes someplace useful, and is connected thereto in some conventional manner (e.g., by a wire bond to a terminal or pad on an integrated circuit die).

The termination technique shown in FIG. 1 is effective at very high frequencies, say, in excess of 30 GHz. In part, this is due to the small size of the geometries involved. They are still small in relation to the wavelengths involved. That, and the fact that the path to ground is very direct, helps mitigate any problems caused by stray reactances. (Strays are the bane of instrument grade terminations, especially when they come in large packages, say, ones designed for use in 7 mm connectors, such as type N and APC 7.)

The characteristic impedance Z₀ of the coplanar transmission line of FIG. 1 is determined in a known manner by the dielectric constant of the KQ material and the dimensions of the transmission line structure. Thus, the coplanar transmission line of FIG. 1 may be fabricated to have a particular characteristic impedance, such as 50 Ω, or perhaps 75 Ω, as desired. It will be appreciated that resistors 7 and 8 will each have a resistance of twice the value of Z₀. On the other hand, however, it may be the case that no particular or constant value of characteristic impedance is required or desired, and the what is being fabricated is simply shielded conductors for conveyance to a load resistor (the parallel combination of 7 and 8) of bias or control signals.

Before proceeding, however, a brief note is in order concerning the ground plane 3. As a true ground plane it will perform best if it is indeed a broad sheet of metal, and that is what the figure shows. On the other hand, the portions of such a ground plane not beneath the transmission line do not afford any particular benefit to the transmission line, insofar as it is a transmission line considered in isolation. The situation may become more complex if there are other circuits located to one side of the transmission line that require strong RF currents to be carried in a ground plane; good practice would be to keep such currents out of the shield for the transmission line.

It will thus be appreciated that either the portion of an entire ground plane that is directly beneath the transmission line, or a sufficiently wide meandering ribbon of ground metal, forms what we have called the ground shield that forms the “shielded” part of the shielded coplanar transmission line.

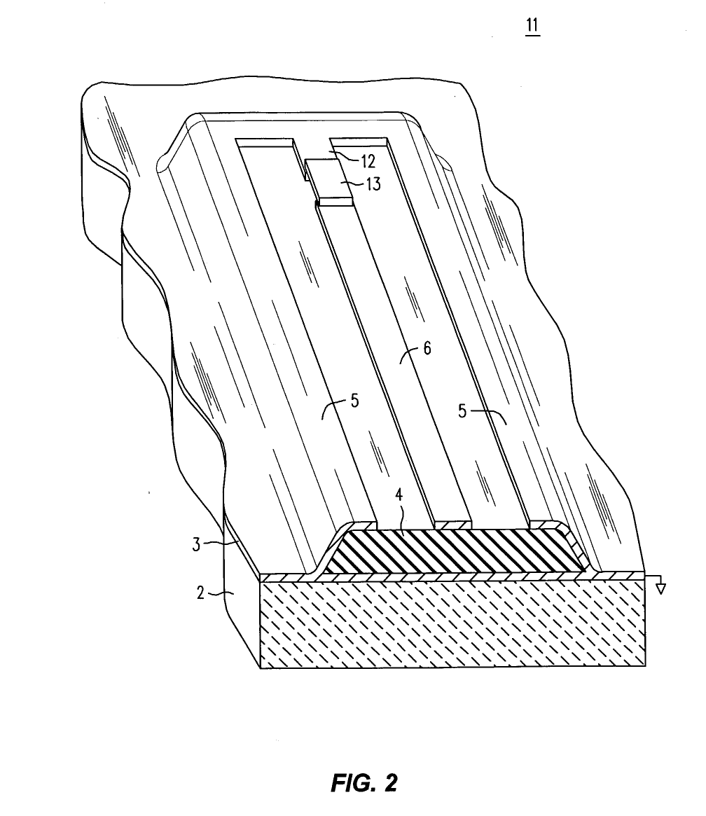

Refer now to FIG. 2, which is a top perspective cut-away view 11 of a distal end of a shielded coplanar transmission line fabricated upon a ceramic substrate 2 and terminated by a single Z₀ resistor 13 extending along the direction of the center conductor strip 6 and beyond the end of the center conductor strip to reach a grounded end (12) of the transmission line. The view 11 of FIG. 2 is quite similar to that of FIG. 1, and most of the reference numbers are the same, since they refer to items that correspond either exactly or very nearly so. The elements of the transmission lines of FIGS. 1 and 2 are fabricated using the same techniques. The difference is that there is only a single termination resistor 13, and the pad 12 that it goes to from the center conductor strip 6 is along an extension of the path taken by the center conductor strip 6.

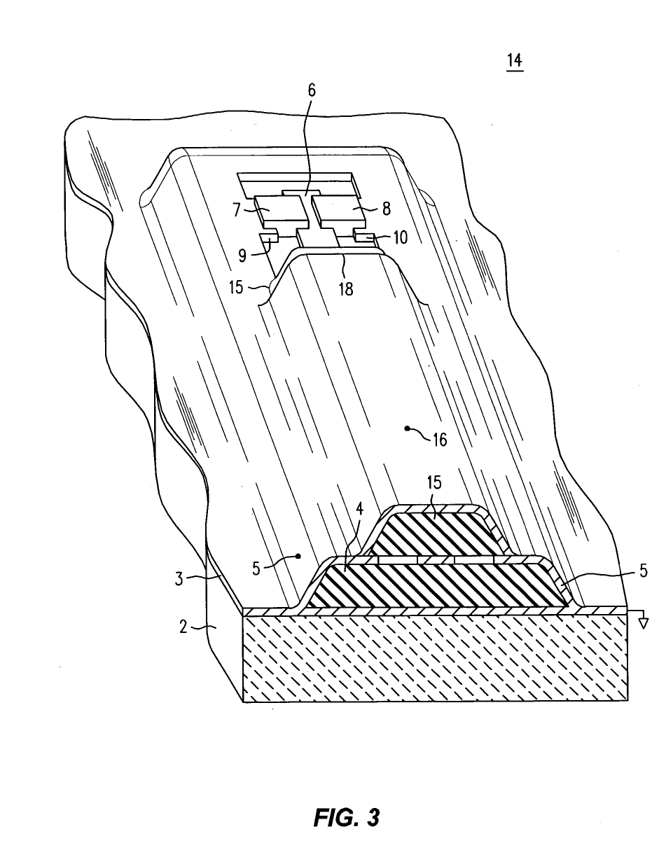

Now refer to FIG. 3, which is a top perspective cut-away view 14 of a distal end of a quasicoaxial transmission line fabricated upon a ceramic substrate 2 and terminated by a pair of R=2Z₀ resistors 7 and 8, each extending from the center conductor strip 6 to a different grounded side (9, 10) of the transmission line. FIG. 3 bears a definite resemblance to FIG. 1, and indeed, the structure of FIG. 1 may be taken as exactly the starting point for fabricating that of FIG. 3. Insofar as being a termination for a transmission is concerned, they are identical; the difference is in the transmission line itself. Accordingly, the elements of FIG. 3 that correspond to ones in FIG. 1 have the same reference numbers. So, let us assume that we have the structure of FIG. 1 as a starting point, and describe the additional steps needed to produce the one shown in FIG. 3.

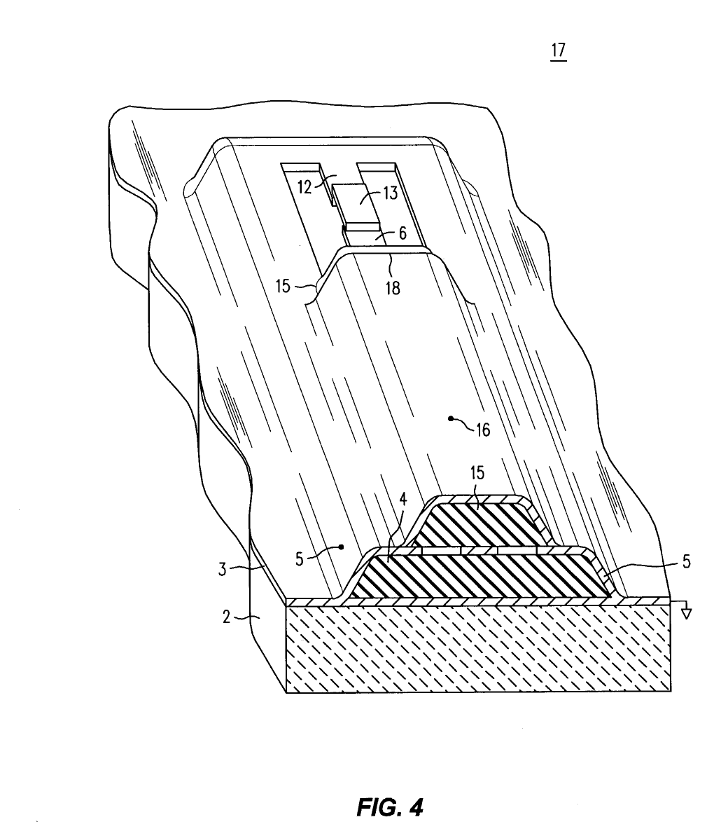

Those additional steps are these: a second ribbon 15 of KQ dielectric material is deposited over the top of the transmission line, save in the region of the termination resistors; and, a layer 16 of Au is deposited over that second ribbon 15, save that it stops at location 18 to avoid too closely approaching the center conductor strip 6. The resulting transmission line that approaches the termination resistors 7 and 8 is what in the Background we termed a quasi-coaxial transmission line. Note that it is fully shielded, and that it has been fabricated somewhat differently than described in the incorporated '730 B1 Patent. (In that Patent the base ribbon of KQ is laid on the ground plane, a center conductor is formed on top of that, and then another ribbon of KQ is overlaid on all that, after which one layer of metal is deposited over both ribbons of KQ.) Now refer to FIG. 4, which is a top perspective cut-away view 17 of a distal end of a quasicoaxial transmission line fabricated upon a ceramic substrate 2 and terminated by a single Z₀ resistor 13 extending along the direction of the center conductor strip 6 and beyond the end of the center conductor strip to reach a grounded end 12 of the transmission line. FIG. 4 is like FIG. 2, but with the quasicoaxial transmission line of FIG. 3. As for FIGS. 1 and 3, corresponding elements in both FIGS. 2 and 4 have identical references numbers.

We claim:

1. A terminated transmission line comprising:
a substrate having a work surface;
a metallic ground surface disposed upon the work surface of the substrate;
a base ribbon of KQ dielectric material disposed upon the ground surface, the base ribbon of KQ dielectric material having two sides, an end and atop surface, in addition to that in contact with the ground surface, a region of contact between the ground surface and the two sides and end of the base ribbon of KQ dielectric material forming a perimeter;
a metallic center conductor strip disposed upon the top surface of the base ribbon of KQ dielectric material;
a metallic side conductor disposed upon the two sides and end of the base ribbon of KQ dielectric material, extending onto the top surface of the base ribbon to within a selected and generally uniform distance from the metallic center conductor strip, and also extending, along the length of the perimeter, onto the metallic ground surface and being in electrical contact therewith; and
a resistance electrically connected to an end of the center conductor strip, extending beyond that end in the direction of the center conductor strip, and connected to that portion of the metallic side conductor disposed on the end of the base ribbon of KQ dielectric material.

2. A transmission line as in claim 1 wherein the transmission line has a selected characteristic impedance of Z₀ and the value R of the resistance is R=Z₀.

3. A transmission line as in claim 1 wherein the metallic ground surface, the metallic center conductor and the metallic side conductor are of gold.

4. A transmission line as in claim 1 further comprising:
a covering ribbon of KQ dielectric material disposed upon the top surface and disposed upon and covering the center conductor strip but leaving the resistance uncovered, the covering ribbon having a top, two sides and an end, each of the two sides being in physical contact along their length with proximate portions of the metallic side conductor; and
a metallic covering layer disposed upon the top and two sides of the covering ribbon of KQ dielectric material, and along the lengths of the two sides of the covering ribbon, being in physical and electrical contact with the metallic side conductor.

5. A transmission line as in claim 4 wherein the metallic covering layer is of gold.

6. A terminated transmission line comprising:
a substrate having a work surface;
a metallic ground surface disposed upon the work surface of the substrate;
a base ribbon of KQ dielectric material disposed upon the ground surface, the base ribbon of KQ dielectric material having two sides, an end and a top surface, in addition to that in contact with the ground surface, a region of contact between the ground surface and the two sides and end of the base ribbon of KQ dielectric material forming a perimeter;
a metallic center conductor strip disposed upon the top surface of the base ribbon of KQ dielectric material;
a metallic side conductor disposed upon the two sides and end of the base ribbon of KQ dielectric material, extending onto the top surface of the base ribbon to within a selected and generally uniform distance from the metallic center conductor strip, and also extending, along the length of the perimeter, onto the metallic ground surface and being in electrical contact therewith;
a first resistance electrically connected to an end of the center conductor strip, extending at a right angle to the center conductor strip, and connected to an opposing portion of the metallic side conductor disposed on one side of the base ribbon of KQ dielectric material; and
a second resistance electrically connected to the end of the center conductor strip, extending in a direction opposite that of the first resistance, and connected to an opposing portion of the metallic side conductor disposed on another side of the base ribbon of KQ dielectric material.

7. A transmission line as in claim 6 wherein the transmission line has a selected characteristic impedance of Z₀ and the value R of each the first and second resistances is R=2Z₀.

8. A transmission line as in claim 6 wherein the metallic ground surface, the metallic center conductor and the metallic side conductor are of gold.

9. A transmission line as in claim 6 further comprising:
a covering ribbon of KQ dielectric material disposed upon the top surface and disposed upon and covering the center conductor strip but leaving the first and second resistances uncovered, the covering ribbon having a top, two sides and an end, each of the two sides being in physical contact along their length with proximate portions of the metallic side conductor; and
a metallic covering layer disposed upon the top and two sides of the covering ribbon of KQ dielectric material, and along the lengths of the two sides of the covering ribbon, being in physical and electrical contact with the metallic side conductor.

10. A transmission line as in claim 9 wherein the metallic covering layer is of gold.
